(19) United States
(12) Patent Application Publication
(10) Pub. No.: US 2005/0009610 A1
(43) Pub. Date: Jan. 13, 2005

(54) Game system that uses collection card, game machine, and storage medium that stores game program

(75) Inventors: Shigeru Miyamoto, Kyoto (JP); Hiroyuki Kimura, Kyoto (JP); Kiyoshi Koda, Kyoto (JP)

Correspondence Address: NIXON & VANDERHYE, PC, 1100 N GLEBE ROAD, 8TH FLOOR, ARLINGTON, VA, 22201-4714, US

(73) Assignee: Nintendo Co., Ltd., Kyoto (JP)

(21) Appl. No.: 10/887,482

(22) Filed: Jul. 9, 2004

(30) Foreign Application Priority Data
Jul. 10, 2003 (JP) 2003-272875

(51) Int. Cl. A63F 13/00

(52) U.S. Cl. 463/43

(57) ABSTRACT

A game system includes a game machine, and is a system for playing an interlocking game between a collection card and the game machine. In the collection card, game data for the interlocking game is recorded in a mechanically readable manner, and this game data is read out by a card reader, which is temporarily stored in a WRAM of the game machine. A game process is applied to the game data in accordance with a game program and an operation input by a player. Furthermore, it is determined whether or not this game achieves a predetermined condition, that is, it is determined whether or not the game is cleared, for example, and as long as the predetermined condition is achieved, the game data and clear information of the game are saved in a backup RAM 44.

### BACKGROUND OF THE INVENTION

1. Field of the Invention

The present invention relates to a game system that uses a collection card, a game machine, and a storage medium that stores a game program. More specifically, the present invention relates to a game system that uses a collection card, a game machine, and a storage medium that stores a game program for playing an interlocking game based on game data recorded in the collection card.

2. Description of the Prior Art

One example of such a kind of a conventional game system is disclosed in, for example, Japanese Patent Laying-open No.2001-334012. This game system (referred to as prior art 1) is a game system in which an identifying code of a character and characteristic expressing data recorded in a playing card in a mechanically readable manner are read out so as to perform an interlocking game process having the characteristic expressing data being added to a game program stored in a game information storage medium. The identifying code and the characteristic expressing data read out from the playing card are temporarily stored in a RAM of a game machine.

In addition, in Japanese Patent Laying-open No.5-135232, disclosed is a game-use IC card having a storing element capable of rewriting the game data. This game-use IC card (referred to as prior art 2) is a card capable of being rewritten to difference game data by paying a data-rewriting fee at a toy store, and etc. However, if the card is rewritten without good reasons, the data-rewriting fee becomes expensive so that unless the game written in the game-use IC card is cleared, the game data is made not to be rewritten.

In the prior art 1, the data read out from the playing card is only temporarily stored in the RAM of the game machine, and is not saved in a backup memory. Therefore, it is needed to allow the playing card to be read at each time that the interlocking game that uses the playing card is played, and thus, this leads to a problem of taking a long time. Furthermore, it is thought that the data read out from the playing card is saved into the backup memory based on this prior art 1. However, in this case, there are problems in that if the read data is merely saved without any thought, the data of the playing card is easily copied, that it is not possible to give a sense of achievement when clearing the game, and etc.

Furthermore, in the prior art 2, only a condition of clearing the game is set regarding whether or not possible to rewrite the game data stored in the game-use IC card. That is, the prior art 2 relates to a data rewriting process toward the game-use IC card itself. However, the prior art 2 does not aim to apply any process regarding the game data read out from the game-use IC card. Still furthermore, this game-use IC card is not a collection card, not a card that saves the read-out data into the backup memory on condition that the game based on the game data read out from the collection card is cleared, for example.

### SUMMARY OF THE INVENTION

Therefore, it is a primary object of the present invention to provide a novel game system that uses a collection card, game machine, and storage medium that stores a game program.

It is another object of the present invention to provide a game system that uses a collection card, a game machine, and a storage medium that stores a game program capable of preventing game data recorded in the collection card from easily being copied, and increasing an interesting aspect of a game.

It is another object of the present invention to provide a game system that uses a collection card, a game machine, and a storage medium that stores a game program capable of eliminating a trouble of reading the collection card for many times after a predetermined condition is achieved.

A game system according to the present invention is a game system for playing an interlocking game between the collection card and a game machine by using a collection card on which its content is printed in a visually recognizable manner. In this game system that uses the collection card, a data recording area in which game data for the interlocking game is recorded in a mechanically readable manner is formed in the collection card. The game machine comprises an external information reading means, a temporary storing means, a game program storing means, an operating means, a game processing means, a displaying means, a condition determining means, a backup storing means, and a writing controlling means. The external information reading means is a means for reading out the game data recorded in the data recording area of the collection card. The temporary storing means temporarily stores the game data read out by the external information reading means. The game program storing means stores a game program for the interlocking game. The operating means is operated by a player. The game processing means applies a game process to the game data stored in the temporary storing means according to the game program and an operation from the operating means. The displaying means displays an image based on a process result of the game processing means. The condition determining means determines whether or not a game based on the game data achieves a predetermined condition. The backup storing means saves a plurality of game data. The writing controlling means writes the game data into the backup storing means when it is determined by the condition determining means that the predetermined condition is achieved.

More specifically, the game system (10: reference number corresponding in a preferable embodiment described later. Hereinafter, the same is true.) is a game system that uses a collection card (14) on which its content is printed in a visually recognizable manner so as to play an interlocking game between the collection card and a game machine (12). In the game recording area (72) of the collection card, game data (80-92) for the interlocking game is recorded in a mechanically readable manner. The game data recorded in the collection card is read out by an external information reading means (28, 46, 48, 102), and the read game data is temporarily stored in a temporary storing means (32). In addition, a game program (102-122) for the interlocking game is stored in a game program storing means (42), and an operating means (22) is operated by a player. The game processing means (28, 104, S57) applies a game process to the game data stored in the temporary storing means according to the game program and an operation from the operating means. The displaying means (20, 28, 34, 106, S57) displays an image based on a game process result. The condition determining means (28, 108, S59) determines whether or not a game based on the game data achieves a predetermined condition. In addition, when it is determined that the predetermined condition is achieved, the writing controlling means (28, 110, S69, S73) writes the game data into the backup storing means (44).

Therefore, in a case of playing the game based on the game data read out from the collection card, unless the predetermined condition is achieved, the read game data is not saved in the backup storing means so that it is possible to prevent the game data recorded in the collection card from easily being copied. That is, possible to prevent the game data from being easily saved without any restrictions. Furthermore, if the predetermined condition is achieved, it is possible to save the game data recorded in the collection card in the backup storing means, and therefore, it is possible to motivate a willingness to collect the game data, thus possible to increase an interesting aspect of the game. In addition, after the predetermined condition is achieved, the game data recorded in the collection card is saved in the backup storing means so that in a case of playing the same game, it is possible to prevent a trouble of allowing the collection card to be read many times.

In a certain embodiment, the condition determining means determines whether or not the game based on the game data is cleared. The backup storing means includes a game data storing area that stores the game data and a clear information storing area that stores clear information of the game based on the game data. The writing controlling means writes the game data into the game data storing area, and writes the clear information of the game based on the game data into the clear information storing area when it is determined by the condition determining means that the game based on the game data is cleared.

More specifically, the condition determining means (S59) determines, as the predetermined condition, whether or not the game based on the game data is cleared. In addition, the writing controlling means (S69, S73, S75, S85) writes the game data into the game data storing area (142) of the backup storing means, and writes the clear information of the game based on the game data into the clear information storing area (144) when it is determined that the game based on the game data is cleared. Therefore, after clearing the game that uses the collection card, the game data recorded in the collection card is saved, and the clear information of the game is saved so that even in a case of being the game that uses the same collection card, different data is saved according to a play content, thus possible to increase an interesting aspect of the game.

In a certain aspect, the game machine further comprises a selecting means for allowing the player to select any one of the game data by displaying the game data stored in the temporary storing means and the game data stored in the backup storing means in a recognizable manner. The game processing means applies a game process to the game data selected by the selecting means according to the game program and an operation from the operating means.

More specifically, the selecting means (28, 114, S41, S53, 150) displays the game data stored in the temporary storing means and the game data stored in the backup storing means in a recognizable manner so that the player is allowed to select any one of the game data. In addition, the game processing means applies a game process to the selected game data according to the game program and the operation. Therefore, the game data already saved and the game data newly read out from the collection card are displayed in a recognizable manner, thus possible to selectively play the game. This makes it possible for the player to easily select a game intended to play, and possible to stimulate a willingness to collect, thus the interesting aspect of the game is increased.

In another aspect, the game machine further comprises a backup determining means for determining whether or not the game data already exists in the backup storing means when it is determined by the condition determining means that the game based on the game data is cleared, and a change determining means for determining whether or not there is a change in the clear information of the game based on the game data when it is determined by the backup determining means that the game data already exists. The writing controlling means performs no writing when it is determined by the change determining means that there is no change, and rewrites only the clear information of the game based on the game data when it is determined by the change determining means that there is the change.

More specifically, the backup determining means (28, 116, S63) determines whether or not the game data already exists in the backup storing means when it is determined by the condition determining means that the game based on the game data is cleared. The change determining means (28, 118, S77) determines whether or not there is a change in the clear information of the game based on the game data when it is determined by the backup determining means that the game data already exists. In addition, the writing controlling means (S79) performs no writing when it is determined by the change determining means that there is no change, and rewrites only the clear information of the game based on the game data when it is determined by the change determining means that there is the change. Therefore, in a case of playing once again the game based on the game data already saved, and clearing the game, the clear information is updated if the clear information is different from the last time, thus possible to allow the player to increase a willingness to play the same game many times, which makes it possible to provide a game not to become easily bored.

A game machine according to the present invention is a game machine used in a game system that uses a collection card in which a data recording area in which game data for an interlocking game is recorded in a mechanically readable manner is formed, and its content is printed in a visually recognizable manner so as to play the interlocking game between the collection card. The game machine comprises an external information reading means, a temporary storing means, a game program storing means, an operating means, a game processing means, a displaying means, a condition determining means, a backup storing means, and a writing controlling means. The external information reading means is a means for reading out the game data recorded in the data recording area of the collection card. The temporary storing means temporarily stores the game data read out by the external information reading means. The game program storing means stores a game program for the interlocking game. The operating means is operated by a player. The game processing means applies a game process to the game data stored in the temporary storing means according to the game program and an operation from the operating means. The displaying means displays an image based on a process result of the game processing means. The condition determining means determines whether or not a game based on the game data achieves a predetermined condition. The backup storing means saves a plurality of game data. The writing controlling means writes the game data into the backup storing means when it is determined by the condition determining means that the predetermined condition is achieved.

A storage medium that stores a game program according to the present invention is a storage medium that stores a game program for saving game data in a game machine used in a game system that uses a collection card in which a data recording area in which game data for an interlocking game is recorded in a mechanically readable manner is formed, and its content is printed in a visually recognizable manner so as to play the interlocking game between said collection card, and comprising an external information reading means, a temporary storing means, a game program storing means, an operating means, and a backup storing means. The external information reading means of the game machine is a means for reading the game data recorded in the data recording area of the collection card. The temporary storing means temporarily stores the game data read out by the external information reading means. The game program storing means stores a game program for the interlocking game. The operating means is operated by a player. The backup storing means saves a plurality of game data. This game program for saving game data allows a processor of the game machine to execute a game processing step, a condition determining step, and a writing controlling step. The game processing step applies a game process to the game data stored in the temporary storing means according to the game program for the interlocking game and an operation from the operating means. The condition determining step determines whether or not a game based on the game data achieves a predetermined condition. The writing controlling step writes the game data into the backup storing means when it is determined by the condition determining means that the predetermined condition is achieved.

In such the game machine and the storage medium in which the game program is stored, similar to the above-described game system, unless the predetermined condition is achieved in the interlocking game, the read game data is not saved into the backup storing means so that it is possible to prevent the game data recorded in the collection card from being easily copied. In addition, it is possible to increase a willingness to collect the game data, thus possible to increase the interesting aspect of the game. Furthermore, in a case of playing the same game, it is possible to eliminate a trouble of reading the collection card many times.

According to the present invention, in a case of playing the game based on the game data read out from the collection card, unless the predetermined condition is achieved, the read game data is not saved into the backup storing means so that it is possible to prevent the game data recorded in the collection card from being easily copied or saved, without any restrictions. In addition, if the predetermined condition is achieved, it becomes possible to save the game data recorded in the collection card into the backup storing means so that it is possible to increase a willingness to collect the game data, thus possible to increase the interesting aspect of the game. In addition, after the predetermined condition is achieved, the game data recorded in the collection card is saved into the backup storing means so that in a case of playing the same game, it is possible to eliminate a trouble of reading the collection card many times.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an outline view showing one example of a game system that uses a collection card of one embodiment of the present invention;

FIG. 2 is a block diagram showing one example of internal structure of the game system of a FIG. 1 embodiment;

FIG. 3 is an illustrative view showing one example of a course card as the collection card used in the game system of the FIG. 1 embodiment;

FIG. 4 is an illustrative view showing one example of game data recorded in the course card of FIG. 3;

FIG. 5 is an illustrative view showing one example of a memory map of a ROM of a card reader in FIG. 2;

FIG. 6 is an illustrative view showing one example of a memory map of a backup RAM of the card reader in FIG. 2;

FIG. 7 is a flowchart showing one example of a card reading operation in the game system of the FIG. 1 embodiment;

FIG. 8 is a flowchart showing one portion of one example of a game operation in the game system of the FIG. 1 embodiment;

FIG. 9 is a flowchart showing a portion succeeding to FIG. 8;

FIG. 10 is an illustrative view showing one example of a course selection table screen; and

FIG. 11 is an illustrative view showing one example of a course information screen.

### DETAILED DESCRIPTION OF THE PREFERRED EMBODIMENTS

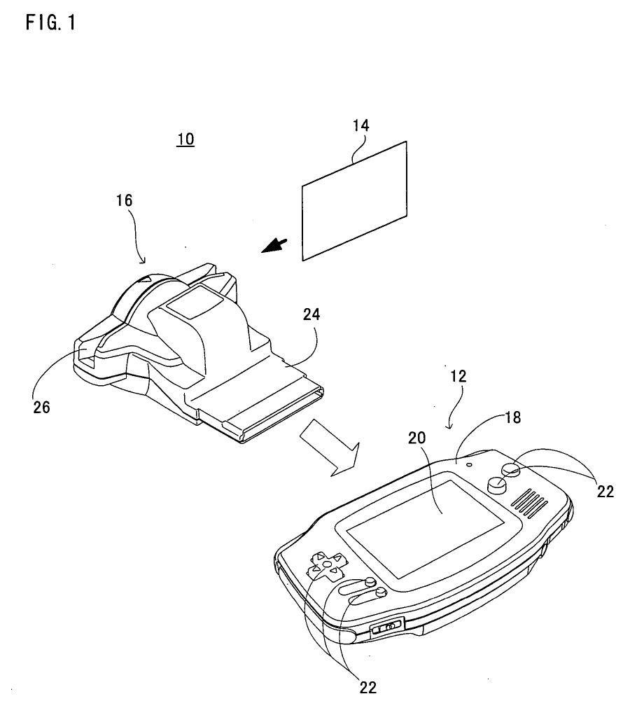

A game system (also hereinafter briefly referred to as a “game system”) 10 that uses a collection card of this embodiment shown in FIG. 1 is a game system for playing an interlocking game that correlates a game machine 12 and a collection card 14, and includes the game machine 12, the collection card 14, and a card reader 16.

As understood from FIG. 1, a handheld-type game machine, and etc., are applied to the game machine 12, for example, and the card reader 16 for reading out data recorded in the collection card 14 is connected to this handheld game machine 12. The card reader 16 of this embodiment is also a game information storage medium that stores a game program and the data.

It is noted that this game machine 12 is not limited to the handheld-type, and a video game machine used to be connected to a home-use television receiver, for example, a PC (personal computer), and etc., may be applied thereto. In this case, an optical information storage medium such as a CD-ROM, a DVD, and etc., and various kinds of information storage media such as a magnetooptical disk, or magnetic disk, and etc., may be applied as the game information storage medium. In addition, a means for reading out the data of the collection card 14 is provided integrally with a video game machine, the PC, and etc., or connected externally thereto.

The game machine 12 includes a housing 18, and at an approximately center portion of a front side of the housing 18, a color liquid crystal display (LCD) 20 is provided as a display. On this LCD 20, a game image including a game world, a game character, and etc., is displayed.

On either side of the LCD 20, provided is an operation portion 22, which is an operating means operated by a player. The operation portion 22 includes a cross button, a start button, a select button, an A button, a B button, an L button, an R button, and etc., for example. The cross button functions as a direction switch, and is capable of horizontally and vertically moving the player character (player object), a cursor, and etc., displayed on the LCD 20 by operating one of four depressing portions. The start button is used for instructing starting the game, and so forth, and the select button is used for selecting a game mode, and so forth. Primarily, the A button is used for determining an item designated by the cursor, and so forth, and the B button is used for canceling the selected item, and so forth. In addition, as a result of the A button, the B button, the L button, and the R button being operated one by one or in combination of another button, it becomes possible to allow the player object displayed on the LCD 16 to take an arbitrary action determined in advance by each operation such as throw, catch, jump, cut with a sword, start talking, and so forth, for example.

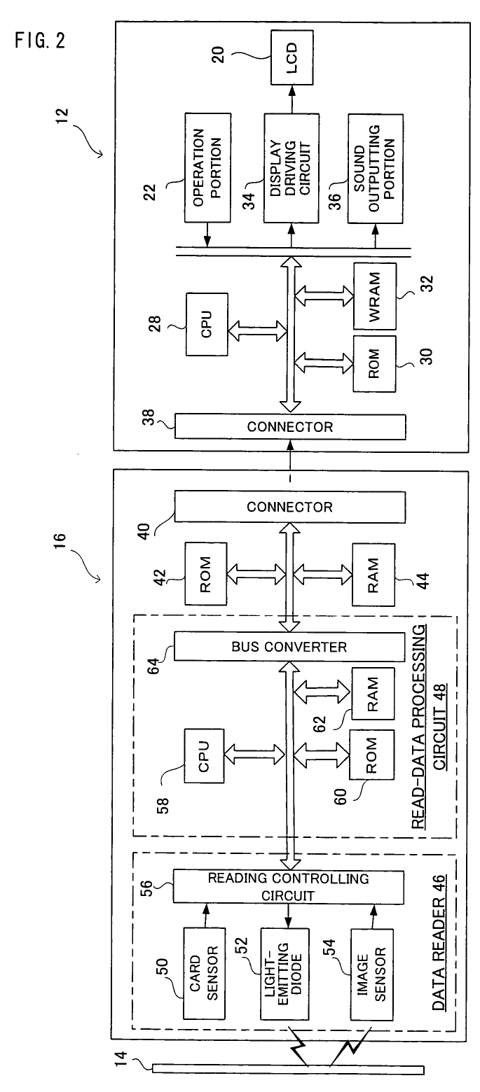

On a far side of an upper surface of the housing 18, an inserting entry not shown is provided, and an edge portion 24 of the card reader 16 is inserted into this inserting entry to be detachably attached. At an internal portion of the inserting entry, and an aperture of the edge portion 24 of the card reader 16, a connector 38 and a connector 40 (FIG. 2) capable of making a connection therebetween are provided, respectively. Thus, when the connector 38 and the connector 40 are connected, the card reader 16 and the game machine 12 are electrically connected, which renders the card reader 16 accessible by a CPU 28 (FIG. 2) of the game machine 12. A power is supplied to the game machine 12 from a battery set to the game machine 12 or a home-use wall outlet, and etc., connected via an AC adaptor, and the power is supplied from the game machine 12 to the card reader 16 in a case of being attached to the game machine 12.

In the card reader 16, provided is a guide groove 26 for guiding a movement of the collection card 14 when the data is read out. In the guide groove 26, provided is a data reader 46 (FIG. 2), and if the collection card 14 is moved inside this guide groove 26, the data recorded in the collection card 14 is read out.

FIG. 2 shows electrical structure of the game machine 12 and the card reader 16. Referring to this FIG. 2, the game machine 12 includes the CPU 28, this CPU 28 is also referred to as a processor or a computer, and etc., and responsible for controlling the whole game machine 12. To the CPU 28, connected are an ROM 30, a WRAM 32, the operation portion 22, a sound outputting portion 36, and the connector 38 via an internal bus. In addition, the LCD 20 is also connected thereto via a display driving circuit 34.

In the ROM 30, stored in advance are a program for executing a process at a time of starting the game machine 12, and etc. The WRAM 32 is a readable/writable memory, and used a working area or a buffer area of the CPU 28. The CPU 28 executes a game program stored in the ROM 42 of the card reader 16, temporarily stores temporary data, which is being executed, into the WRAM 32, and executes a game process. An operation input signal corresponding to an operation of the operation portion 22 is applied to the CPU 28, and temporarily stored in the WRAM 32. Therefore, the CPU 28 executes a process according to an instruction of a player (user) supplied through the operation portion 22. Furthermore, game image data generated as a result of the CPU 28 executing the game program is stored into a VRAM not shown, and the image data stored in the VRAM is output onto the LCD 20 by the display driving circuit 34. Therefore, a game screen (display screen), and etc., including a character, a background, and etc., is displayed on the LCD 20. The sound outputting portion 36 applies an analog conversion to sound data such as a game sound effect, a game music (BGM), or a sound, and etc., supplied from the CPU 28, and supplies this sound data to a speaker not shown. Therefore, the sound such as the game sound effect, the BGM, the sound, and etc., is output from the speaker.

In the card reader 16, contained are the connector 40, the ROM 42, the RAM 44, the data reader 46, and a read-data process circuit 48. To the connector 40, connected are the ROM 42, the RAM 44, and the read-data process circuit 48 via a bus, and to the read-data process circuit 48, connected is the data reader 46. Therefore, as described above, when the card reader 16 is attached to the game machine 12, and the connector 40 and the connector 38 are thereby connected, the CPU 28 of the game machine 12 are electrically connected to the ROM 42, the RAM 44, and the read-data process circuit 48.

In the ROM 42, stored in a predetermined manner are the game program and the data. The RAM 44 is a memory for saving backup data. In this embodiment, as described later, in a case of satisfying a predetermined condition, the game data read out from the collection card 14, clear information, and etc., too, are stored in this RAM 44. To this RAM 44, applied is a flash memory, which is a non-volatile memory. However, a ferroelectric memory (FeRAM), an EEPROM, and etc., as another non volatile memory may be applicable. In addition, an SRAM, a DRAM, and etc., that use a battery as a power may be used for the RAM 44.

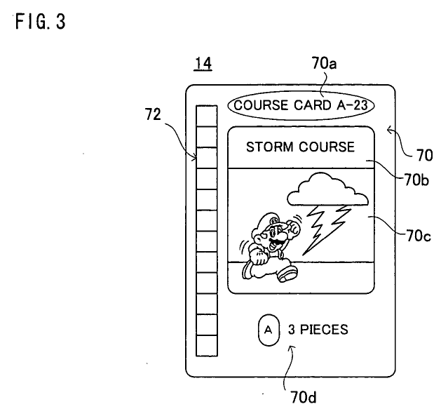

The data reader 46 is a reader for mechanically reading the data recorded in the collection card 14. In this embodiment, the data is recorded in the collection card 14 in a two-dimensional bar-code manner, for example, so that an optical reader is applied. The data reader 46 includes a card sensor 50, a light-emitting diode (LED) 52, an image sensor (CCD sensor) 54, and a reading controlling circuit 56. The card sensor 50 detects a period from a time that an edge of the collection card 14 is inserted into the guide groove 26 until a time that a rear edge comes out of the guide groove 26, produces a pulse during that period, and activates the light-emitting diode 52, the image sensor 54, and the reading controlling circuit 56 by the pulse. The light-emitting diode 52 emits light during a time that the pulse is input from the card sensor 50, and radiates an information recording area 72 (FIG. 3) of the collection card 14 inserted inside the guide groove 26. The image sensor 54 is a sensor for receiving reflected light of the light-emitting diode 52, and optically reading out the data recorded in the information recording area 72 of the collection card 14. In addition, the image sensor 54 temporarily stores a dot pattern in a block unit of the two-dimensional bar code, converts the dot pattern into bit serial data after dissolving into dot data of one line (or one line in a row direction perpendicular to the moving direction) of the moving direction of the collection card 14, and supplies this data to the reading controlling circuit 56. The reading controlling circuit 56 converts the read data into a data format appropriate for temporarily storing in the RAM 62 described later, and supplies this data to the read-data process circuit 48.

The read-data process circuit 48 is a circuit for processing the data read by the data reader 46, and by being applied to an appropriate process by a recording system of the data, converts into a data format to be processed by the CPU 28 of the game machine 12. The read-data process circuit 48 includes a CPU 58, an ROM 60, an RAM 62, and a bus converter 64. The ROM 60 stores in a predetermined manner a program for converting the data read out by the data reader 46 into a predetermined data format, and a program for controlling writing into the RAM 62, and a program for controlling a transfer to the CPU 28 via the bus converter 64. In addition, the CPU 58 writes the read data into the RAM 62 in a byte unit based on the program stored in the ROM 60, and allows the RAM 62 to temporarily store this data. In addition, the CPU 58 sequentially reads out the data, and allows the bus converter 64 to convert the data into a data format of a predetermined format and transfer the data to the game machine 12.

The collection card 14 is a card for providing the game data for the interlocking game, and formed of paper, plastic, and etc., in a rectangular shape, for example. The collection card 14 includes an image-pattern display area 70 and the information recording area 72 in which the game data is recorded, as shown in FIG. 3. In addition to a charm of an image pattern printed in the image-pattern display area 70, uniqueness of the game data recorded in the information recording area 72 makes the collection card 14 a trading card valuable for a collector.

It is possible to think various kinds of the interlocking games, and however, in this embodiment, as an example, assumed is a game in which the player character defeats an enemy character appearing on a course, collects a coin, and advances the course, with an object of safely reaching a goal of the course, for example. Furthermore, one piece of the collection card 14 provides data regarding one course, for example. Therefore, the collection card 14 of this embodiment is also referred to as a “course card”, and by obtaining a plurality of the course cards 14, a user is capable of additionally enjoying the game on a plurality of different courses.

In this FIG. 3, the information recording area 72 is formed in such a manner as to be along one side on one main surface of the collection card 14, for example, and the remaining large area is the image pattern displaying area 70. It is noted that it is needless to say that an arrangement of each of these areas 70 and 72 may be changed as required, and the information recording area 72 may be formed in such manner as to be along the two sides, or the three sides or the four sides depending on a data amount to be recorded, for example. In addition, it may be possible that a plurality of the collection cards are combined so as to construct one course card, and the data is recorded by being dividing into the information recording area 72 of each collection card.

In the image-pattern display area 70, printed is a content of the information recorded on this collection card 14 in a visually recognizable manner by using a text, a symbol, a picture, and etc. More specifically, in the image-pattern display area 70 in FIG. 3, printed are a course number 70a, a course name 70b, an illustration 70c indicating its characteristic so as to inform of what kind of courses, the number of coins 70d of advance coins subject to be acquired that exist in the course, and etc.

In the information recording area 72, recorded is the game data for the interlocking game in a mechanically readable manner. In this embodiment, an optically readable manner is adopted as described above, and a print of the two-dimensional bar code is used, for example.

It is noted that besides the above-described mechanically-readable optical manner, an electrical manner, a magnetic manner, and etc., may be used as the mechanically readable recording manner of the game data. As an electrical storing manner, the collection card 14 is constructed of an IC card, and the game data is made to be stored in the ROM or the RAM of an IC chip. As a magnetic storing manner, the collection card 14 is constructed of a magnetic stripe card, and the game data is made to be stored into a magnetic tape. It is noted that in these cases, as the data reader 46, a reader corresponding to each recording manner is used. More specifically, an IC card reader is used in a case of the IC card, and a magnetic reader is used in a case of the magnetic stripe.

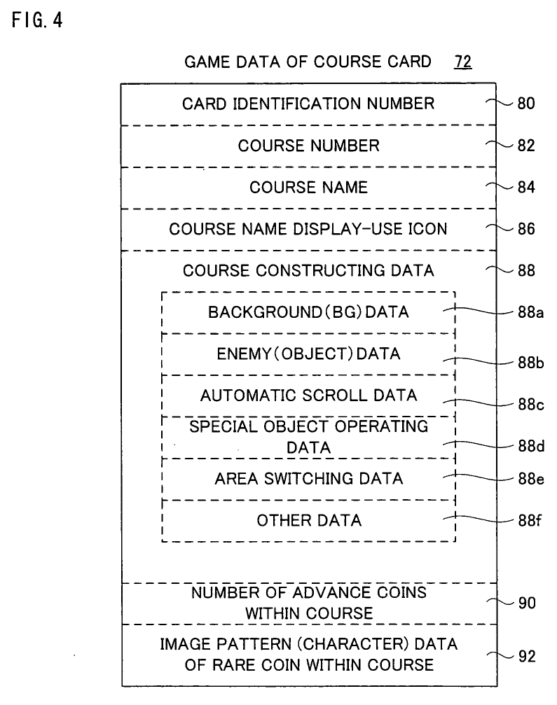

In FIG. 4, a content of the game data recorded in the information recording area 72 of the course card 14 of this embodiment is shown. This game data (card data) includes an identification number of the card 80, a course number 82, a course name 84, a course name display-use icon 86, course constructing data 88, the number of advance coins 90 within the course, image pattern (character) data 92 of a rare coin within the course of the card, and etc., for example. In a case of the course card 14 shown in FIG. 3, data indicating “A-23” is stored in the course number 82, the data indicating “storm course” is stored in the course name 84, and the data indicating “3” is stored in the number of advance coins 90 within the course. The course name display-use icon 86 is image data (dot data) for displaying an icon 176 on a course information screen 170 (FIG. 11). The course constructing data 88 includes background (BG) data 88a for displaying a background image of the course, enemy object data 88b for displaying the enemy appearing in the course, automatic scroll data 88c for controlling a scroll of the background, special object action data 88d for controlling an action of a special object appearing in the course, area switching data 88e for controlling a switching to another distant area of the display area, and other data 88f necessary for the game play in the course. Image pattern (character) data 92 of the rare coin inside the course is stored in a case that the rare coin is arranged in the course, and is the dot data for displaying the rare coin. It is noted that regarding the advance coin, there is arranged one coin or there are arranged a plurality of coins in the course, and the advance coin is a special coin to be acquired in due order. Different from an ordinary coin or the advance coin, the rare coin is arranged only in a special course, and thus, has scarcity value.

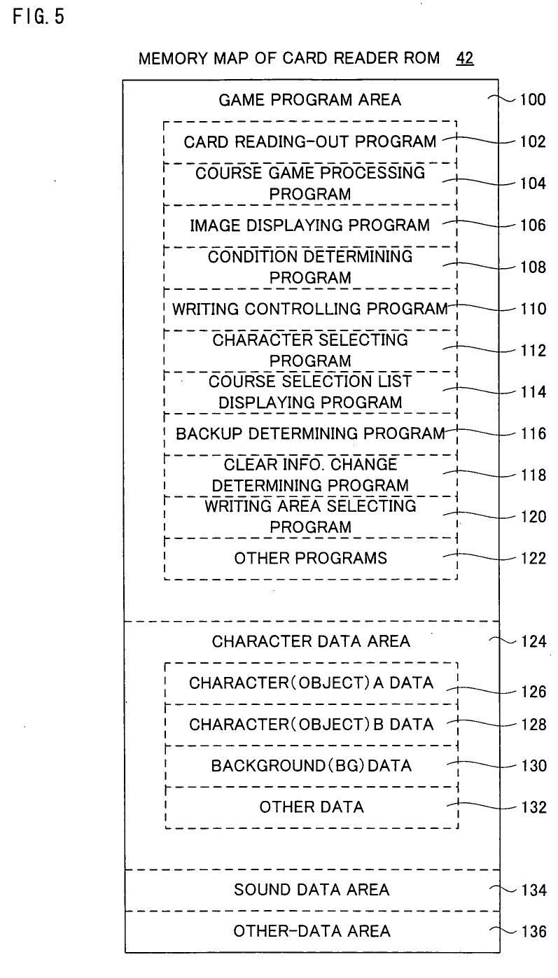

In FIG. 5, one example of a memory map of the ROM 42 of the card reader 16 is shown. In the ROM 42, a game program storing area 100 in which the game program is stored in a predetermined manner is formed. The CPU 28 of the game machine 12 executes a process according to this game program. The game program includes a card reading-out program 102, a course game processing program 104, an image displaying program 106, a condition determining program 108, a writing controlling program 110, a character selecting program 112, a course selection list displaying program 114, a backup determining program 116, a clear information change determining program 118, a writing area selecting program 120, and other programs 122.

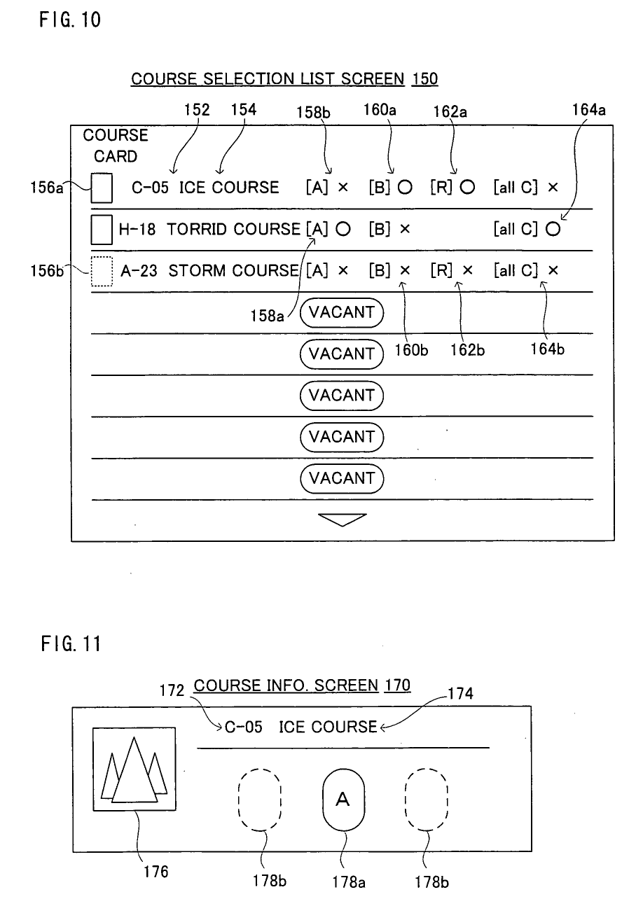

The card reading-out program 102 is a program for obtaining the game data of the card read out by the card reader 16. The course game processing program 104 is a program for advancing the course game based on the read game data and the operation input signal from the operation portion 22, and etc. The image displaying program 106 is a program for displaying on the LCD 20 the game image generated by the course game processing program 104, and etc. The condition determining program 108 is a program for determining whether or not a predetermined condition for permitting to save the card data in the game based on the card data is satisfied. The writing controlling program 110 is a program for controlling a writing into the RAM 44 of the card reader 16 of the backup data generated in the WRAM 32 in conjunction with the game process. The character selecting program 112 is a program for allowing the player character operated by the player to be selected from a plurality of the player characters. The course selection list displaying program 114 is a program for displaying a list screen 150 (FIG. 10) of the course and an information screen 170 (FIG. 11), and etc., for selecting the course to be played. The backup determining program 116 is a program for determining whether or not the game data of the same course card is already saved as a backup in the RAM 44. The clear information change determining program 118 is a program for determining whether or not there is a point to be changed in the clear information of the course game already saved in the RAM 44. The writing area selecting program 120 is a program for allowing the storing area to be selected in a case of writing into the RAM 44 of the game data.

In addition, a character data area 124, too, is formed in the ROM 42. In this area 124, data 126 regarding a character (object) A as the player character and data 128 regarding a character (object) B, data 130 regarding the background (BG), and other data 132 are stored. The player is capable of selecting the player character from the character A or B. In other data 132, data regarding the enemy character, and etc., are stored, for example.

Furthermore, in the ROM 42, formed are a sound data storing area 134 in which the sound data such as the BGM, the sound effect, and a sound (or voices) are stored, and other-data area 136 for various kinds of another necessary data. In the other-data area 136, data regarding a course map screen, a course selection list screen, a course information screen, a writing area selecting screen, and etc., are stored.

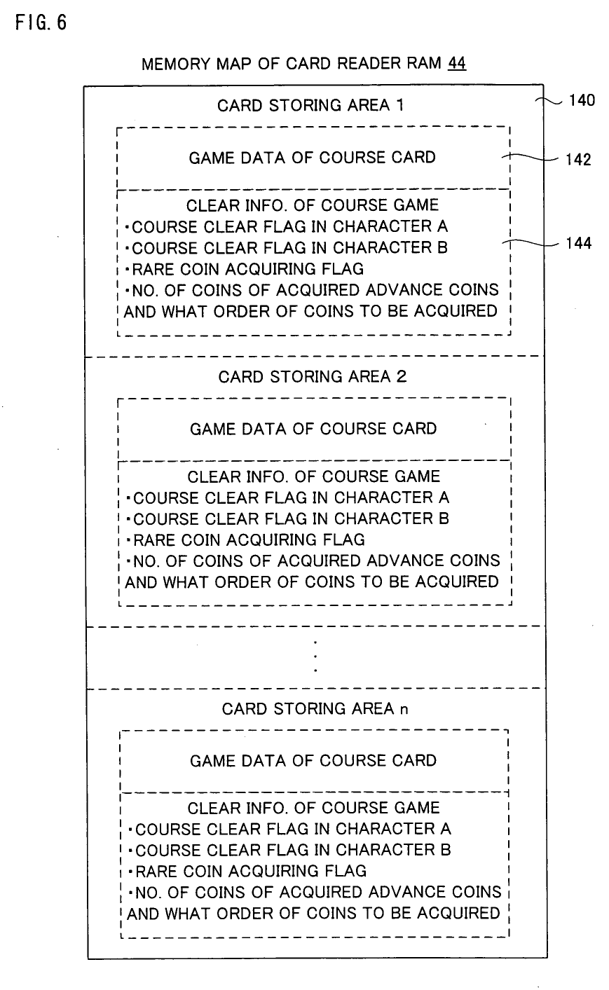

In FIG. 6, one example of a memory map of the RAM 44, which is the backup storing means, is shown. As shown in FIG. 6, in the RAM 44, there are formed a plurality of card storing areas 140 for storing the backup data regarding the game based on the collection card 14 corresponding to a capacity thereof. Into this card storing area 140, in a case that a predetermined condition is satisfied in the interlocking game, the backup data including the game data of the course card 14 is to be written.

Each card storing area 140 includes a game data storing area 142 for storing the game data, and a clear information storing area 144 for storing the clear information of the game based on the game data. In this embodiment, in the game data storing area 142, all data read out from the course card 14, that is, all data (see FIG. 4) recorded in the course card 14, are stored. In addition, in the clear information storing area 144, a course clear flag in the character A, a course clear flag in the character B, a rare-coin acquiring flag, the number of acquired advance coins, data regarding in what order of the coins to be acquired, and etc., are stored as the clear information of the course game. Each of the course clear flag in the character A and the course clear flag in the character B is set to be turned on in a case that the character A and the character B are selected as the player character, the game is played, and the course game is cleared. The rare-coin acquiring flag is a flag set in a case that the rare coin exists in the course, and set to be turned on in a case that the player character acquires the rare coin during the game. These pieces of the clear information are used for displaying the course selection list screen 150 shown in FIG. 10 and the course information screen 170 shown in FIG. 11, and so forth.

It is noted that in FIG. 6, the game data storing area 142 and the clear information storing area 144 are provided in each of the card storing areas 140. However, it may be possible that the memory map is constructed of two areas, that is, an area having a plurality of game data storing areas 142 and an area having a plurality of clear information storing areas 144, and the game data of each game data storing area 142 and the clear information of the clear information storing area 144 corresponding thereto are stored in a recognizable manner by an identification number, and etc.

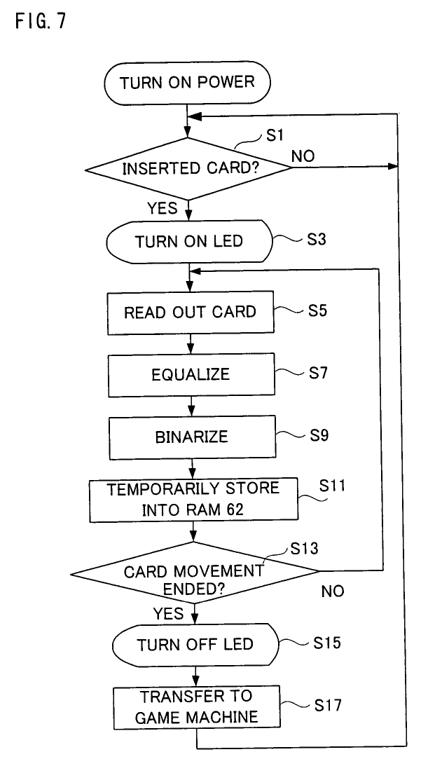

In FIG. 7, shown is a flowchart for describing one example of an operation of the data reader 46 and the read data processing circuit 48 of the card reader 16. When a power of the game machine 12 is input, the CPU 58 starts the operation of this FIG. 7 based on the program stored in the ROM 60.

In a step S1, it is determined whether or not there is an inserting detection of the collection card 14 based on an output of the card sensor 50. In a case that there is no inserting detection, the process is waited until the card sensor 50 detects the collection card 14. When the collection card 14 is inserted into the guide groove 26, the card sensor 50 detects the collection card 14 and produces the pulse. In response thereto, the light emitting diode (LED) 52 is driven in a flashing manner in a step S3.

If the player inserts into the guide groove 26 the side on which the information recording area 72 of the collection card 14 is formed, and starts a movement from its edge portion to the rear portion, the image sensor 54 optically reads out the data recorded in the information recording area 72 in a two-dimensional bar-code manner in a step S5. The data read out by the image sensor 54 is applied to an equal process by the reading controlling circuit 56 in a step S7, and converted into binarized data, which is “1” or “0” in a dot unit, in a step S9. In a succeeding step S11, the CPU 58 converts the binarized data into a row unit and into a predetermined format of one block of a data row, and writes the data into the RAM 62 so as to be temporarily stored therein.

In a step S13, it is determined whether or not the movement of the collection card 14 is ended, and if the process is in a pulse producing period during which the card sensor 50 is detecting the collection card 14, the process returns to the step S5 so as to repeat the operations from the step S5 to the step S13 until the collection card is not detected any more. The operations of the step S5—the step S13 are repeated until the data of all blocks recorded in the information recording area 72 are read out. If it is detected that the movement of the collection card 14 is ended in the step S13, the light-emitting diode 52 is turned off in a step S15. Thus, the data recorded in the information recording area 72 of one piece of the collection card 14 is read out and temporarily stored in the RAM 62.

Furthermore, in a succeeding step S17, the recorded data of the collection card 14 stored in the RAM 62 is read out by the CPU 58 in order, and transferred to the game machine 12 via the bus converting circuit 64, the connector 40, and the connector 38. It is noted that this transfer may be processed according to an instruction of the CPU 28 of the game machine 12. Upon completion of the step S17, the process returns to the step S1, and waited once again until a time that it is detected that the collection card 14 is inserted into the guide portion 26.

Thus, in this game system 10, the data of the collection card 14 is read out by the card reader 16, and transferred to the game machine 12. The CPU 28 of the game machine 12 obtains the read data transferred from the card reader 16, and writes the read data into the WRAM 32 so as to be temporarily stored. Thereafter, the CPU 28 of the game machine 12 analyzes the read data written in the WRAM 32, and is to execute the game process based on this game data as required. In addition, in this embodiment, in a case of clearing the interlocking game based on the card data, the backup data including the read data is written into the RAM 44, and saved therein.

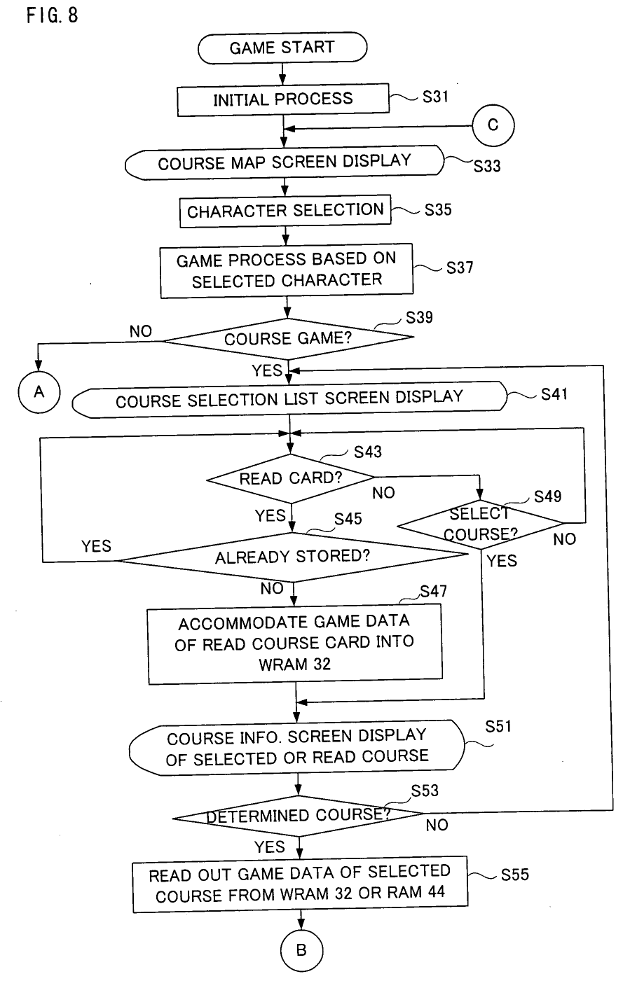

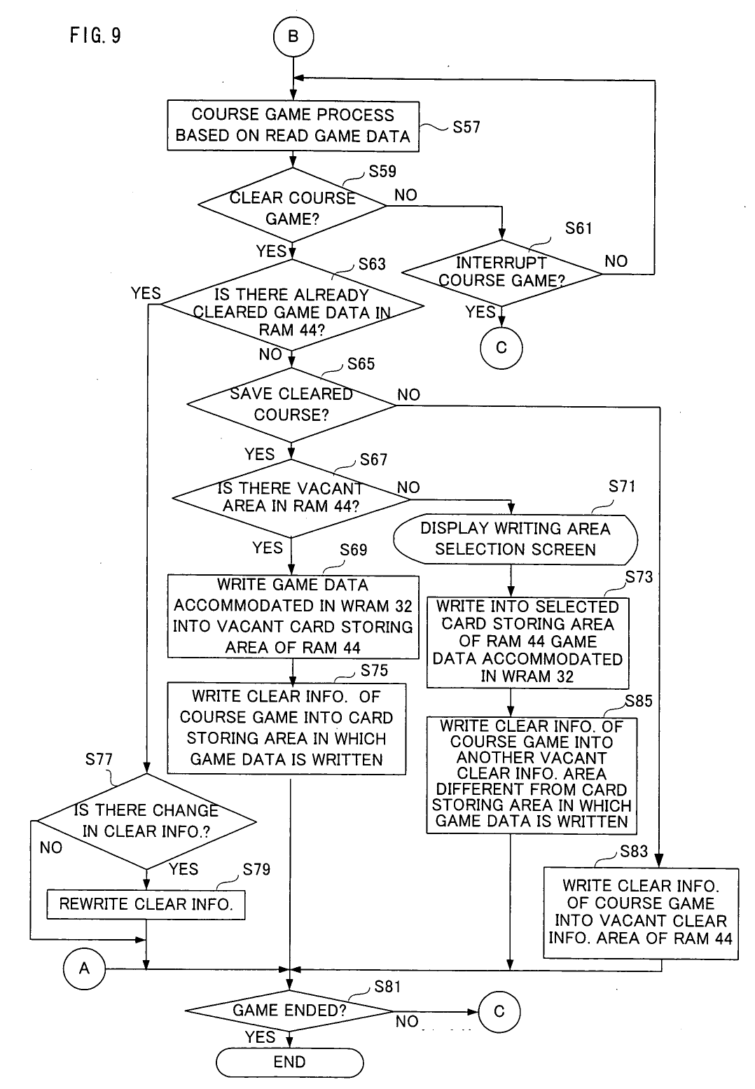

In FIG. 8 and FIG. 9, one example of the game operation of this game system 10 is shown. When the player attaches the card reader 16 into the game machine 12, and inputs the power, the CPU 28 of the game machine 12 executes a starting process based on the program stored in the ROM 30, and executes the game process based on the program stored in the ROM 42 of the card reader 16. In a first step S31 in FIG. 8, the CPU 28 executes an initial process such as performing an initial clearing of the WRAM 32, and in a case that the backup data is stored in the RAM 44 of the card reader 16, reading out the data into the WRAM 32, and so forth, for example.

Next, in a step S33, the CPU 28 allows the course map screen to be displayed on the LCD 20. How each course is arranged in the game world is shown on the course map screen. In addition, it is possible to select the player character from a plurality of candidates on this screen. In a case that the operation portion 22 is operated by the player, and the character is selected on this screen, the CPU 28 selects the character based on the operation input signal from the operation portion 22 in a step S35, and in a succeeding step S37, the CPU 28 executes the game process based on the selected character, and the selected character is made to be appeared on the screen. Thereafter, on this screen, it is possible to select a play of the course game as the interlocking game, a play of another game, various kinds of environmental settings, and etc, for example.

Then, in a step S39, it is determined whether or not the play of the course game as the interlocking game is selected based on the operation input from the operation portion 22. If “NO” in this step S39, that is, in a case that a play other than the play of the course game is selected, a corresponding process (not shown) is executed, and the process advances to a step S81 in FIG. 9.

On the other hand, if “YES” in the step S39, the CPU 28 allows the course selection list screen 150 to be displayed on the LCD 20 in a step S41. On the course selection list screen 150, as described in FIG. 10, a list of playable courses is shown. The displayed courses include a course already saved in the RAM 44 as a result of the predetermined condition being achieved in the past, a course newly read out by the card reader 16 and temporarily stored in the WRAM 32, an initial course stored in the ROM 42 in advance, and etc. Regarding information of each course, besides the course number 152, and the course name 154, a result of the past play of the course, and etc., are displayed.

In FIG. 10, on the left side of the course number 152, shown are an icon (image pattern that describes an outline of the card by a straight line) 156a that indicates a saved course of which the details saved in the RAM 44 as a result of being already cleared, or an icon (image pattern that describes the outline of the card by a dotted line) 156b that indicates a not-yet-saved course not cleared yet, and merely temporarily stored in the WRAM 32. Thus, it is recognizably shown that the data of which collection card 14 is already saved so that the player is capable of easily selecting which game to play, and it is possible to stimulate a willingness of the player to collect the collection card 14, thus increasing the interesting aspect of the game.

In addition, on the right side of the course name 154, shown are various kinds of icons corresponding to the result of the past play. Based on the course clear flag in the character A, an icon 158a indicating that the course is cleared in the character A, or an icon 158b indicating that the course is not cleared in the character A are shown, for example. In addition, based on the course clear flag in the character B, an icon 160a indicating that the course is cleared in the character B, or an icon 160b indicating that the course is not cleared in the character B are shown. Furthermore, based on the rare-coin acquiring flag, in a case that the rare coin exists in the course, an icon 162a indicating that the rare coin exits and is acquired, or an icon 162b indicating that the rare coin exists and is not acquired are shown. It is noted that in a case that no rare icon exists in the course, as understood from a column of a “torrid course” in FIG. 10, the icon regarding the rare icon is not displayed. In addition, based on the number of advances coins data 90 within the course and the number of coins data of the acquired advance coin, and etc., an icon 164a indicating that all advance coins in the course are acquired by a single play, or an icon 164b indicating that all advance coins in the course are not acquired by a single play are shown.

The player looks at this course selection list screen 150 so as to easily understand a saving situation of the data, the result of the past play, and etc., and is capable of easily selecting the course intended to play. Furthermore, the player is capable of playing the course by adjusting a cursor not shown, and etc., to a course column intended to play, and operating the A button, for example. Or, as a result of another new collection card 14 being prepared, and read by the card reader 16, it becomes possible to add the new course.

Subsequently, returning to the. flowchart in FIG. 8, the CPU 28 determines whether or not the collection card 14 is read in a step S43. More specifically, it is determined whether or not the read data is transferred from the card reader 16, or whether or not the CPU 28 accessing the RAM 62 of the card reader 16, and the data read out from the collection card 14 is temporarily stored, for example. If “YES” in this step S43, the CPU 28 determines whether or not the read data is the data of the same course of the data already stored in the RAM 44 or the WRAM 32. More specifically, it is determined whether or not the card identification number 80 is the same, for example. If “YES” in this step S45, the game data of that collection card 14 is already obtained so that the process returns to the step S43. On the other hand, if “NO”, the CPU 28 accommodates (temporarily stores) the game data of the read course card 14 into a predetermined area of the WRAM 32 in a succeeding step S47, and then, advances to a step S51. It is noted that in this step S47, in a case that the read data is temporarily stored in the RAM 62, the game data is made to be transferred to a game machine 12 side, and written into the WRAM 32, and in a case that the game data is already transferred to the game machine 12 side, the game data is made to be accommodated in a predetermined area of the WRAM 32 as required.

On the other hand, if “NO” in the step S43, the CPU 28 determines whether or not there is a course selection by detecting the operation input from the operation portion 22 in a succeeding step S49. If “YES” in this step S49, the process advances to the step S51, and if “NO”, the process returns to the step S43.

In the step S51, the CPU 28 allows the course information screen 170 of the selected or read course to be displayed on the LCD 20. Thus, in a case that a new collection card 14 is read out, the course information screen 170 is made to be automatically displayed.

The course information screen 170 is a screen for displaying course information as shown in FIG. 11, and on the course information screen 170, shown are a course number 172, a course name 174, a course name display-use icon 176 having such an image pattern as to allow a characteristic of the course to appear, for example. Furthermore, on this course information screen 170, the number of advance coins within the course, and an acquiring situation of the advance coin within the course based on the result of the past play are displayed. More specifically, the icons having the same number as the number of pieces of the advance coins within the course are aligned in a horizontal one line, for example, and the aligning order of each icon corresponds to an arranging order of the advance coin from a start point of the course. In addition, based on the data regarding what is the number of the advance coin to be acquired, which is included in the clear information, an icon 178a having the image pattern of a coin for indicating that this coin is already acquired is shown in an already-acquired location, and a icon 178b having an image pattern, in which only an outline of the coin is shown by a dotted line, for example, for indicating that this coin is not acquired yet, is shown in a not-yet-acquired location. In this example of FIG. 11, it is understood that three pieces of the advance coins are arranged within the course, and the second coin from the start point is already acquired. Thus, the player is capable of comprehending the play situation in the past, a characteristic of the course, and etc., by looking at the course selection list screen 150 of FIG. 10 and the course information screen 170 of FIG. 11, and thereby, selecting the course intended to play.

Subsequently, in a step S53, the CPU 28 determines whether or not the course to be played is determined. More specifically, it is determined whether or not the A button or the start button, and etc., that means “determined” are operated, or the B button that means “cancelled” is operated, for example, while the course information screen 170 is displayed. If “NO” in the step S53, the process returns to the step S41 so as to display the course selection list screen 150. At this time, in a case that a new collection card 14 has been read out, a column of information of the course is added.

On the other hand, if “YES” in the step S53, the CPU 28 reads out the game data of the selected course from the WRAM 32 or the RAM 44 in a step S55. Then, the process advances to a step S57 in FIG. 9.

In the step S57 in FIG. 9, the CPU 28 executes the course game process based on the read game data. Herein, based on the operation input from the operation portion 22, the course game processing program 104, and etc., temporal data is being generated in the WRAM 32, and the course game is being advanced. As a result of the player operating the cross button, the A button, and etc., for example, the coins are acquired when the player character moves to a location of the advance coin, the rare coin, and etc.. In addition, the game image data generated based on this process result is displayed on the LCD 20 as the game image by the image displaying program 106, and etc. Furthermore, in a case that there is a change to the data to be stored as the clear information of the course game, that is, in various cases such as a case that the course is cleared in the character A or B, a case that the rare coin is acquired, a case that the advance coin is acquired, and other cases, the clear information is generated on the WRAM 32.

Subsequently, in a step S59, the CPU 28 determines whether or not the course game is cleared. The CPU 28 determines whether or not the player character reaches a goal point of the course, for example. If “NO” in this step S59, the CPU 28 determines whether or not there is an operation input for interrupting the course game in a succeeding step S61. If “YES” in the step S61, this course game process is ended, and the process returns to the step S33 in FIG. 8 so as to allow the course map screen to be displayed once again. On the other hand, if “NO” in the step S61, the process returns to the step S57 so as to repeat the course game.

Then, if “YES” in the step S59, that is, in a case that the course game is cleared, the CPU 28 determines whether or not the cleared game data already exists in the RAM 44 in a step S63. That is, it is determined whether or not the backup data of the course is already saved in the RAM 44 by clearing the play in the past, based on the identification number data of the card, for example.

If “NO” in the step S63, that is, in a case that the game data of the course is not saved, the CPU 28 determines whether or not to save the backup data of the cleared course in a succeeding step S65. Herein, on the screen, displayed is a message such as “save the data of the cleared course?”, for example, so as to allow the player to select whether or not to save the data.

If “NO” in this step S65, the CPU 28 writes the clear information of the course game generated in the WRAM 32 by the course game process in the step S57 into a vacant clear information area 144 of the RAM 44 in a succeeding step S83. Upon completion of this step S83, the process advances to a step S81.

On the other hand, if “YES” in the step S65, that is, in a case that there is an operation input for showing the saving, and so forth, for example, the CPU 28 access the RAM 44 so as to determine whether or not there is the vacant area in a succeeding step S67.

If “YES” in the step S67, the CPU 28 writes into the game data area 142 of the vacant card storing area 140 of the RAM 44 the game data of the collection card 14 accommodated in the WRAM 32 in a step S69.

In a succeeding step S75, the CPU 28 writes into the clear information area 144 of the card storing area 140 in which the game data is written in the step S69 the clear information of the course game generated in the WRAM 32 by the course game process in the step S57. Upon completion of this step S75, the process advances to the step S81.

On the other hand, if “NO” in the step S67, that is, in a case that there is no vacant area in the RAM 44, the CPU 28 allows a writing area selection screen to be displayed on the LCD 20 in the step S71. On this writing area selection screen, the CPU 28 allows the player to select the area to be written by an overwriting. Then, in a step S73, the CPU 28 writes into the game data area 142 of the card storing area 140 of the RAM 44 selected by the player the game data of the collection card 14 accommodated in the WRAM 32.

In a succeeding step S85, the CPU 28 writes the clear information of the course game generated in the WRAM 32 by the course game process in the step S57 into another vacant clear information area 144, which is different from the clear information area 144 of the card storing area 140 in which the game data is written in the step S73. Upon completion of this step S85, the process advances to the step S81.

On the other hand, if “YES” in the step S63, that is, in a case that the game data of the same course as the cleared course is already saved, the CPU 28 determines whether or not there is a change in the clear information in a step S77. That is, the saved clear information is read out from the RAM 44 into the WRAM 32, for example, and this saved clear information and the clear information generated in the WRAM 32 based on the result of the game play this time are compared. In a case that the cleared player character is different, that the rare coin not acquired is acquired, that the advance coin not acquired is acquired, or that all the advance coins are acquired for the first time in the play this time, and other cases, for example, the change is occurred to the clear information.

If “YES” in the step S77, the CPU 28 rewrites the data in the clear information storing area 144 of the card storing area 140 of the RAM 44 in which the game data of that course is saved to the clear information based on the result of the game play this time in a succeeding step S79. More specifically, regarding the player character not cleared in the game play last time or the rare coin/advance coin not acquired, information cleared and acquired in the game play this time is added. Thereby, thereafter, in a case that the course selection list screen 150 and the course information screen 170 are displayed, the screen on which updated clear information is reflected is to be displayed. Therefore, it is possible to motivate a player's willingness to play the game of the same course, and also render the game least likely to be bored by the player. Upon completion of this step S79, or in a case of “NO” in the step S77 and there is no change in the clear information, the process advances to the step S81.

In the step S81, the CPU 28 determines whether or not to end the game. The CPU 28 allows the player to select whether or not to end the game by displaying on the screen a message such as “end the game?”, for example. If “NO” in this step S81, that is, in a case that there is an operation input indicating that the game is continued, and etc., for example, the process returns to the step S33 in FIG. 8 so as to repeat from the displaying process of the course map screen. On the other hand, if “YES” in the step S81, that is, in a case that there is the operation input indicating that the game is ended, and etc., this game process is ended.

It is noted that in a case of “NO” in the above step S65, only the clear information of the course game is to be written. However, besides the clear information, one portion (all data other than the course constructing data 88, for example) of the game data of the collection card 14 accommodated in the WRAM 32 may be written. Or, in a case of “NO” in the above step S65, none of the data may be saved (written).

Furthermore, in the above step S85, the clear information of the course game is to be additionally written into the vacant clear information area 144. However, if there is no vacant clear information area 144, the clear information may be overwritten into the clear information area 144 of the card storing area 140 in which the game data is written in the step S73.

According to this embodiment, in a case of playing the interlocking game based on the game data read out from the collection card 14, unless the predetermined condition, that is, the clearing of the course, is achieved, the game data read and temporarily stored in the WRAM 32 is not saved, thus possible to prevent the game data recorded in the collection card 14 from easily being copied, that is, from being saved without any restrictions. In addition, if the predetermined condition is achieved, it is possible to save the game data recorded in the collection card 14, thus possible to increase a player's willingness to collect the game data, thus increase the interesting aspect of the game. Furthermore, after the predetermined condition is achieved, the game data recorded in the collection card 14 is saved in the RAM 44 so that in a case of playing the game by the same collection card 14 later, it is possible to eliminate a trouble of reading the collection card 14 many times.

Furthermore, in addition to saving the game data recorded in the collection card 14, the clear information of that game is saved so that in spite of the game using the same collection card 14, the different data is saved corresponding to the content of the play, thus possible to increase the interesting aspect of the game.

Furthermore, on the course selection list screen 150, for example, the game is made to be selectively playable by displaying the game data already saved and the game data newly read out from the collection card in a recognizable manner so that the player is capable of easily selecting the game intended to play, and possible to stimulate the player's willingness to collect the collection card, thus possible to increase the interesting aspect of the game.

In addition, in a case of clearing by playing once again the game based on the game data already saved, it is made to determine whether or not there is the change to the clear information, and the clear information is updated if the clear information is different from last time, thus possible to increase the player's willingness to play the same game for many times, thus possible to provide a game not to become easily bored.

It is noted that in the above embodiment, the predetermined condition that permits to save the game data recorded in the collection card 14 is being the game clear of the interlocking game based on the game data. However, this predetermined condition is not limited to the game clear, and changeable as required. Another example of the predetermined condition may include a condition that 100 or more coins are to be collected, or a condition that the game is played without any mistakes until a predetermined time period is elapsed, and so forth, for example. Furthermore, it may be possible that the predetermined condition is that the two or more conditions are achieved.

In addition, in the above-described embodiment, described is a case that a kind of the games is the course game, and data of the construction of the course, and etc., is recorded in the collection card 14. However, it is needless to say that the kind of the games, the content of the data recorded in the collection card 14, and etc., are arbitrary, and changed as required.

Although the present invention has been described and illustrated in detail, it is clearly understood that the same is by way of illustration and example only and is not to be taken by way of limitation, the spirit and scope of the present invention being limited only by the terms of the appended claims.

1. A game system that uses a collection card on which its content is printed in a visually recognizable manner so as to play an interlocking game between the collection card and a game machine, wherein
said collection card is formed with a data recording area in which game data for the interlocking game is recorded in a mechanically readable manner, and
said game machine comprises:
an external information reading means for reading out said game data recorded in said data recording area of said collection card;
a temporary storing means for temporarily storing said game data read out by said external information reading means;
a game program storing means for storing a game program for said interlocking game;
an operating means operated by a player;
a game processing means for applying a game process to said game data stored in said temporary storing means according to said game program and an operation from said operating means;
a displaying means for displaying an image based on a process result of said game processing means;
a condition determining means for determining whether or not a game based on said game data achieves a predetermined condition;
a backup storing means for saving a plurality of game data; and
a writing controlling means for writing said game data into said backup storing means when it is determined by said condition determining means that said predetermined condition is achieved.

2. A game system that uses a collection card according to claim 1, wherein
said condition determining means determines whether or not the game based on said game data is cleared,
said backup storing means includes a game data storing area that stores said game data and a clear information storing area that stores clear information of the game based on the game data,
said writing controlling means writes said game data into said game data storing area, and writes the clear information of the game based on said game data into the clear information storing area when it is determined by said condition determining means that the game based on said game data is cleared.

3. A game system that uses a collection card according to claim 1, wherein
said game machine further comprises a selecting means for allowing said player to select any one of the game data by displaying said game data stored in said temporary storing means and said game data stored in said backup storing means in a recognizable manner, and
said game processing means applies a game process to said game data selected by said selecting means according to said game program and an operation from said operating means.

4. A game system that uses a collection card according to claim 2, wherein
said game machine further comprises,
a backup determining means for determining whether or not said game data already exists in said backup storing means when it is determined by said condition determining means that the game based on said game data is cleared,
a change determining means for determining whether or not there is a change in the clear information of the game based on the game data when it is determined by said backup determining means that said game data already exists, and
said writing controlling means performs no writing when it is determined by said change determining means that there is no change, and rewrites only the clear information of the game based on said game data when it is determined by said change determining means that there is the change.

5. A game machine used in a game system that uses a collection card in which a data recording area in which game data for an interlocking game is recorded in a mechanically readable manner is formed, and its content is printed in a visually recognizable manner so as to play said interlocking game between the collection card, comprising:
an external information reading means for reading out said game data recorded in said data recording area of said collection card;
a temporary storing means for temporarily storing said game data read out by said external information reading means;
a game program storing means for storing a game program for said interlocking game;
an operating means operated by a player;
a game processing means for applying a game process to said game data stored in said temporary storing means according to said game program and an operation from said operating means;
a displaying means for displaying an image based on a process result of said game processing means;
a condition determining means for determining whether or not a game based on said game data achieves a predetermined condition;
a backup storing means for saving a plurality of game data; and
a writing controlling means for writing the game data into said backup storing means when it is determined by said condition determining means that said predetermined condition is achieved.

6. A storage medium that stores a game program for saving game data in a game machine used in a game system that uses a collection card in which a data recording area in which game data for an interlocking game is recorded in a mechanically readable manner is formed, and its content is printed in a visually recognizable manner so as to play said interlocking game between said collection card, and comprising:
an external information reading means for reading out said game data recorded in said data recording area of said collection card;
a temporary storing means for temporarily storing said game data read out by said external information reading means;
a game program storing means for storing a game program for said interlocking game;
an operating means operated by a player; and
a backup storing means for saving a plurality of game data, wherein
said game program allows a processor of said game machine to execute following steps of:
a game processing step for applying a game process to said game data stored in said temporary storing means according to said game program and an operation from said operating means;
a condition determining step for determining whether or not a game based on said game data achieves a predetermined condition; and
a writing controlling step for writing the game data into said backup storing means when it is determined by said condition determining means that said predetermined condition is achieved.
